(19) United States
(12) Patent Application Publication
(10) Pub. No.: US 2020/0013202 A1
(43) Pub. Date: Jan. 9, 2020

(54) ANALYZER

(71) Applicant: Shimadzu Corporation, Kyoto (JP)

(72) Inventor: Shingo MASUDA, Kyoto (JP)

(73) Assignee: Shimadzu Corporation, Kyoto (JP)

(21) Appl. No.: 16/027,627

(22) Filed: Jul. 5, 2018

(51) Int. Cl. G06T 11/20; G06F 3/0488; G06F 3/0484; G06F 3/14; G01N 30/86

(52) U.S. Cl. CPC G06T 11/206; G06F 3/04883; G06F 3/04845; G01N 2030/025; G01N 30/8651; G06F 2203/04808; G06F 3/14

(57) ABSTRACT

In a gas chromatograph, a display unit is provided in a main body. In addition, a touch panel-type display screen is included in the display unit. Further, a setting processing unit performs setting related to a graph displayed in a graph area based on a touch operation on the graph area of the display screen. For this reason, an operator may perform setting related to the graph displayed in the graph area of the display screen only by performing a touch operation on the touch panel-type display screen provided in the main body.

### FIELD

The present invention relates to an analysis apparatus that displays data obtained based on a detection signal from a detector on a display screen as a graph.

### BACKGROUND

Normally, a data processing apparatus including a personal computer is connected to an analysis apparatus such as a gas chromatograph. A detection signal from a detector included in the analysis apparatus is input to the data processing apparatus, and the data processing apparatus performs an operation based on the detection signal, thereby obtaining data such as a chromatogram (for example, see Patent Literature 1 below).

Various data obtained in this way are displayed on a display unit provided separately from the analysis apparatus. The display unit has a relatively large display screen so that an operator can easily check the data.

### PRIOR ART DOCUMENT

### Patent Literature

[Patent Literature 1] Japanese Patent No. 5,206,504

### SUMMARY

In the conventional analysis apparatus described above, the operator may not check data unless the data processing apparatus is activated. For this reason, the data processing apparatus needs to be activated at all times during analysis, and there arises a problem that power consumption increases when an analysis time becomes long. In addition, it may be convenient for the operator performing an operation on the analysis apparatus when an operation of checking and setting data can be performed in a main body of the analysis apparatus.

Therefore, providing a data processing unit, a display unit, and an operation unit for data processing in the main body of the analysis apparatus is taken into consideration. However, it is difficult to ensure a space only for providing the display unit having a large display screen in the main body of the analysis apparatus. In addition, the operation unit is merely provided with some keys allowing a relatively simple setting operation. For this reason, it is difficult to perform setting related to a graph such as a chromatogram by an operation on the main body.

The invention has been made in view of the above circumstances, and an object of the invention is to provide an analysis apparatus that can easily perform setting related to a graph displayed based on a detection signal from a detector by an operation on a main body.

(1) An analysis apparatus according to the invention includes a main body, a detector, a display unit, a display processing unit, and a setting processing unit. The detector is provided in the main body, detects a sample, and outputs a detection signal. The display unit is provided in the main body and has a touch panel-type display screen. The display processing unit displays a graph in a graph area on the display screen based on the detection signal from the detector. The setting processing unit performs setting related to a graph displayed in the graph area based on a touch operation on the graph area on the display screen.

According to such a configuration, the operator may perform setting related to the graph displayed in the graph area of the display screen only by performing the touch operation on the touch panel-type display screen provided in the main body.

That is, setting related to the graph displayed in the graph area may be easily performed only by an operation on the main body.

(2) In addition, the display processing unit may enlarge and display the graph displayed in the graph area based on a touch operation on the graph area on the display screen. The setting processing unit may perform setting related to the graph based on a touch operation on the graph area in which the graph is enlarged and displayed.

According to such a configuration, the operator may perform setting related to the graph by enlarging and displaying a part to be noticed in the graph displayed in the graph area and performing the touch operation on the graph area subjected to enlarging and displaying.

For this reason, it is possible to perform detailed setting related to the graph only by performing the touch operation on the graph area.

(3) In addition, the display processing unit may display a graph in the graph area by biaxial display of a vertical axis and a horizontal axis, and change a magnification of one of the vertical axis or the horizontal axis in the graph displayed in the graph area based on a touch operation on the graph area on the display screen, thereby enlarging and displaying the graph.

According to such a configuration, it is possible to enlarge and display the graph in a mode in which setting is easily performed in a limited graph area by changing only a magnification of one axis to be set rather than changing magnifications of both the vertical axis and the horizontal axis.

For this reason, it is possible to perform detailed setting related to the vertical axis of the graph or detailed setting related to the horizontal axis of the graph.

(4) In addition, the display processing unit may display a chromatogram when a sample is detected by the detector in the graph area by biaxial display in which a vertical axis represents signal intensity of the detector and a horizontal axis represents time, and change a magnification of the horizontal axis in the chromatogram displayed in the graph area based on a touch operation on the graph area on the display screen, thereby enlarging and displaying the chromatogram. The setting processing unit may set a time based on a touch operation on the graph area in which the chromatogram is enlarged and displayed.

According to such a configuration, it is possible to enlarge and display the chromatogram in a mode in which setting related to time is easy to perform, and then perform the setting in detail.

(5) In addition, the display processing unit may display a graph representing a change in signal intensity when the detector is activated in the graph area by biaxial display in which a vertical axis represents signal intensity of the detector and a horizontal axis represents time, and change a magnification of the vertical axis in the graph displayed in the graph area based on a touch operation on the graph area on the display screen, thereby enlarging and displaying the graph. The setting processing unit may set a threshold value of the signal intensity of the detector based on a touch operation on the graph area in which the graph is enlarged and displayed.

According to such a configuration, it is possible to enlarge and display the graph in a mode in which setting related to the threshold value of the signal intensity of the detector is easy to perform, and then perform the setting in detail.

According to the invention, it is possible to perform setting related to a graph displayed in a graph area of a touch panel-type display screen provided in a main body only by performing a touch operation on the display screen. For this reason, it is possible to easily perform setting related to a graph displayed based on a detection signal from a detector by an operation on the main body.

### BRIEF DESCRIPTION OF THE DRAWINGS

FIG. 1 is a schematic view illustrating a configuration example of a gas chromatograph according to an embodiment of the invention;

FIG. 2 is a block diagram illustrating a specific configuration of a controller and surrounding members of the gas chromatograph of FIG. 1;

FIG. 3 is a schematic view illustrating an example of a display mode of a display screen in a state of a basic screen;

FIG. 4 is a flowchart illustrating a process in a state of a backflush setting mode as an example of a process by the controller;

FIG. 5 is a schematic view illustrating an example in which an entire chromatogram is displayed as an example of a display mode of the display screen in the state of the backflush setting mode;

FIG. 6 is a schematic view illustrating an example in which the chromatogram is enlarged and displayed on a time axis as an example of a display mode of the display screen in the state of the backflush setting mode;

FIG. 7 is a flowchart illustrating a process in a state of an ignition setting mode as an example of a process by the controller;

FIG. 8 is a schematic view illustrating an example in which an entire signal intensity graph is displayed as an example of a display mode of the display screen in the state of the ignition setting mode; and

FIG. 9 is a schematic view illustrating an example in which the signal intensity graph is enlarged and displayed on a signal intensity axis as an example of a display mode of the display screen in the state of the ignition setting mode.

### DESCRIPTION DESCRIPTION

### 1. Overall Configuration of Gas Chromatograph

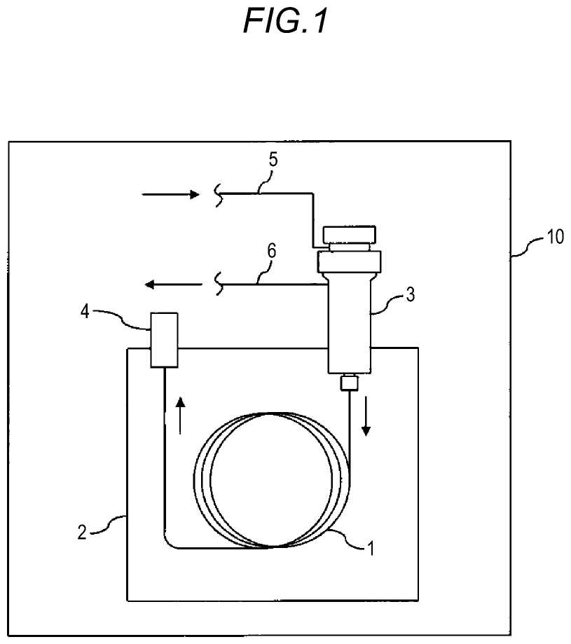

FIG. 1 is a schematic view illustrating a configuration example of a gas chromatograph according to an embodiment of the invention. This gas chromatograph is for performing analysis by supplying a sample gas into a column 1 together with a carrier gas, and includes a column oven 2, a sample introduction portion 3, a detector 4, a hollow main body 10 for accommodating these components, etc. in addition to the column 1.

For example, the column 1 includes a capillary column. The column 1 is accommodated in the column oven 2 together with a heater, a fan, etc. (none of which are illustrated).

The column oven 2 is for heating the column 1, and appropriately drives the heater and the fan at the time of analysis.

The sample introduction portion 3 is for introducing a carrier gas and a sample gas into the column 1, and a sample vaporization chamber (not illustrated) is formed therein. A liquid sample is injected into this sample vaporization chamber, and a sample vaporized in the sample vaporization chamber is introduced into the column 1 together with the carrier gas. In addition, a gas supply flow path 5 and a split flow path 6 communicate with the sample vaporization chamber.

The gas supply flow path 5 is a flow path for supplying a carrier gas into the sample vaporization chamber of the sample introduction portion 3.

The split flow path 6 is a flow path for discharging a part of gas (a mixed gas of the carrier gas and the sample gas) in the sample vaporization chamber to the outside at a predetermined split ratio when the carrier gas and the sample gas are introduced into the column 1 by a split introduction method.

For example, the detector 4 includes a flame ionization detector (FID). That is, when the gas chromatograph is operated, a hydrogen flame is ignited in the detector 4. In addition, the detector 4 successively detects respective sample components contained in the carrier gas introduced from the column 1.

When a sample is measured in this gas chromatograph, first, the hydrogen flame is ignited in the detector 4, and the detector 4 is activated. Then, a sample to be analyzed is injected into the sample introduction portion 3. The sample is vaporized in the sample vaporization chamber. Further, a carrier gas is supplied to the sample vaporization chamber of the sample introduction portion 3 via the gas supply flow path 5.

The sample vaporized in the sample vaporization chamber is introduced into the column 1 together with the carrier gas. Respective sample components contained in the sample are separated in a process of passing through the column 1 and successively introduced into the detector 4.

Then, in the detector 4, the respective sample components contained in the carrier gas introduced from the column 1 are successively detected. In addition, a chromatogram is generated based on a detection result in the detector 4.

In addition, in this gas chromatograph, a backflush operation may be performed. The backflush operation is an operation for discharging an unnecessary component in the column 1 and the sample vaporization chamber of the sample introduction portion 3 by causing the carrier gas to flow backward after a target component passes through the detector 4. When this backflush operation is performed in analysis using the gas chromatograph, it is possible to shorten analysis time and to suppress contamination in the column 1.

### 2. Specific Configuration of Controller and Surrounding Members

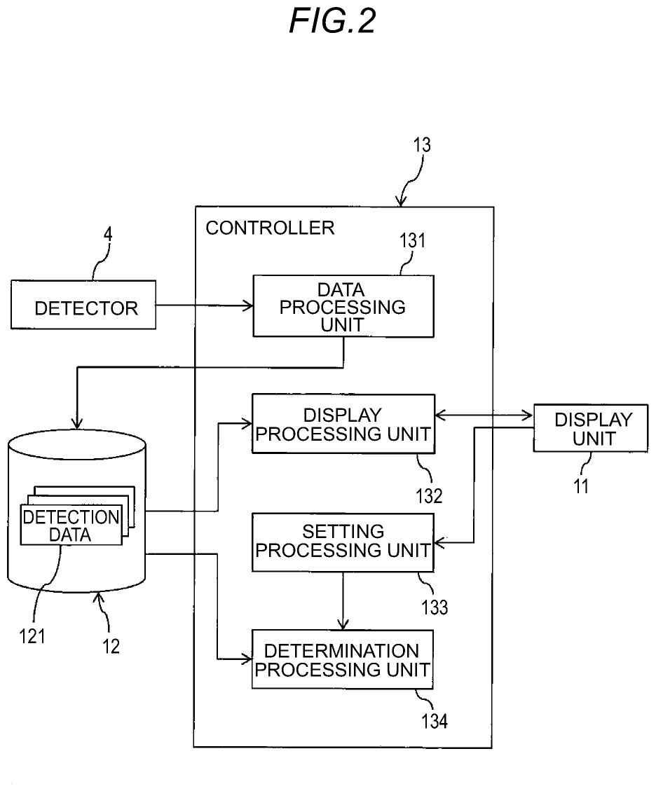

FIG. 2 is a block diagram illustrating a specific configuration of a controller and surrounding members of the gas chromatograph of FIG. 1.

In addition to the detector 4, the gas chromatograph includes a display unit 11, a storage unit 12, and a controller 13.

The display unit 11 is provided in the main body 10 (see FIG. 1). Although described in detail below, the display unit 11 includes a touch panel. That is, in the gas chromatograph, an operator can check information and perform an input operation while conducting analysis using the display unit 11.

For example, the storage unit 12 includes a read only memory (ROM), a random access memory (RAM), etc. The storage unit 12 stores a plurality of pieces of detection data 121.

Each of the plurality of pieces of detection data 121 is data generated based on a detection signal from the detector 4 by a data processing unit 131 described below. Specifically, each of the plurality of pieces of detection data 121 is a chromatogram or signal intensity data when the detector 4 is activated.

For example, the controller 13 includes a central processing unit (CPU). The controller 13 may input or output an electric signal between the detector 4 and the display unit 11. The controller 13 inputs/outputs data to/from the storage unit 12 as necessary. The controller 13 functions as the data processing unit 131, a display processing unit 132, a setting processing unit 133, a determination processing unit 134, etc. when the CPU executes a program.

During analysis, the data processing unit 131 obtains a chromatogram based on the detection signal from the detector 4. In addition, before analysis, the data processing unit 131 obtains signal intensity data based on the detection signal from the detector 4 when the detector 4 is activated. In addition, the chromatogram and signal intensity data generated by the data processing unit 131 are stored in the storage unit 12 as the detection data 121.

The display processing unit 132 performs a process of displaying the chromatogram or the signal intensity data as a graph on the display unit 11 based on the detection data 121 of the storage unit 12. Further, the display processing unit 132 performs a process of changing a display of the chromatogram or the signal intensity data displayed on the display unit 11 based on an input signal from the display unit 11 by operating the touch panel.

The setting processing unit 133 performs setting related to the graph displayed on the display unit 11 based on the input signal from the display unit 11 by operating the touch panel. Examples of the setting related to the graph include setting of a numerical value for each axis of the graph.

The determination processing unit 134 performs determination necessary for an analysis operation of the gas chromatograph based on setting content according to the setting processing unit 133 and the detection data 121 of the storage unit 12, and controls operations of various components of the gas chromatograph in accordance with determination content.

### 3. Screen Configuration of Display Screen

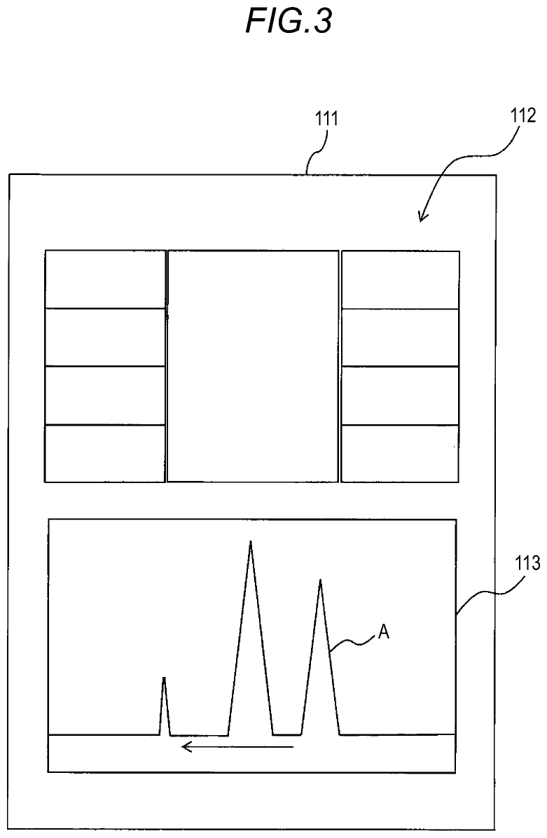

FIG. 3 is a schematic view illustrating an example of a display mode of a display screen 111 in a state of a basic screen.

The display unit 11 includes the display screen 111 having a touch panel type. The display unit 11 is provided in the main body 10 (see FIG. 1), and the operator may check the display screen 111 on the main body 10. Specifically, the display unit 11 is provided on a front surface of the main body 10 so that the operator may easily perform an operation. In addition, an openable and closable door, etc. is normally provided on the front surface of the main body 10. That is, on the front surface of the main body 10, the display unit 11 is disposed in a relatively small space to ensure a space in which the door, etc. is disposed.

The display screen 111 is formed in a substantially rectangular shape. The display screen 111 includes an operation display area 112 and a graph area 113.

The operation display area 112 is disposed on an upper side in the display screen 111. The operation display area 112 is an area for displaying operation states of various components in the gas chromatograph. For example, operation states such as a temperature of the column 1, a temperature and a pressure inside the sample introduction portion 3, a flow rate of the carrier gas supplied into the sample introduction portion 3, a temperature of the detector 4, etc. are displayed in the operation display area 112.

The graph area 113 is disposed on a lower side in the display screen 111. The graph area 113 is an area for displaying a data processing result by the data processing unit 131 as a graph. Specifically, the graph area 113 is an area for displaying a graph based on data stored as the detection data 121 in the storage unit 12. A graph (a graph representing the chromatogram or the signal intensity data) is displayed by biaxial display in which a horizontal axis is time and a vertical axis is signal intensity in the graph area 113.

During analysis in the gas chromatograph, the chromatogram is displayed in real time on the display screen 111 of the display unit 11. That is, during analysis, when the chromatogram is generated by the data processing unit 131 based on the detection signal from the detector 4, data corresponding to the chromatogram is stored in the storage unit 12 as the detection data 121. Further, the display processing unit 132 displays the chromatogram in the graph area 113 of the display screen 111 in real time based on the detection data 121 stored in the storage unit 12.

Specifically, during analysis, a graph A corresponding to a chromatogram is displayed to move from a right to a left in the graph area 113. In the graph A, content displayed on a right end side corresponds to a chromatogram generated in real time. Further, content displayed on a right end side in the graph A moves to the left as time elapses and is no longer displayed in the graph area 113 when time further elapses.

As described above, while the basic screen is displayed on the display screen 111 of the display unit 11, the chromatogram is displayed as the graph A in real time in the graph area 113. Then, the operator conducts various analyses by checking this graph A.

### 4. Control Operation by Controller and Display Mode of Display Screen

(1) Backflush Setting Mode

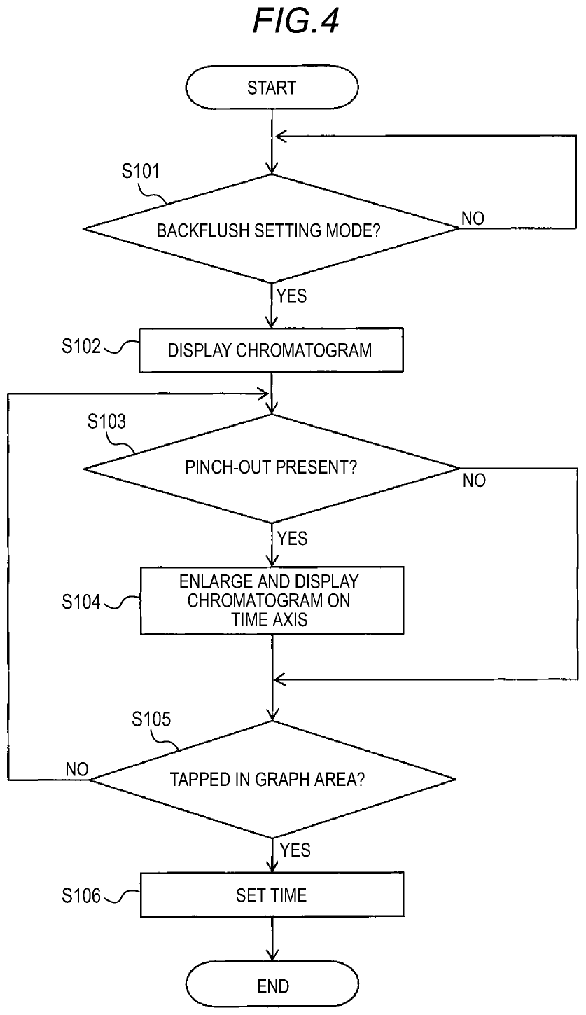

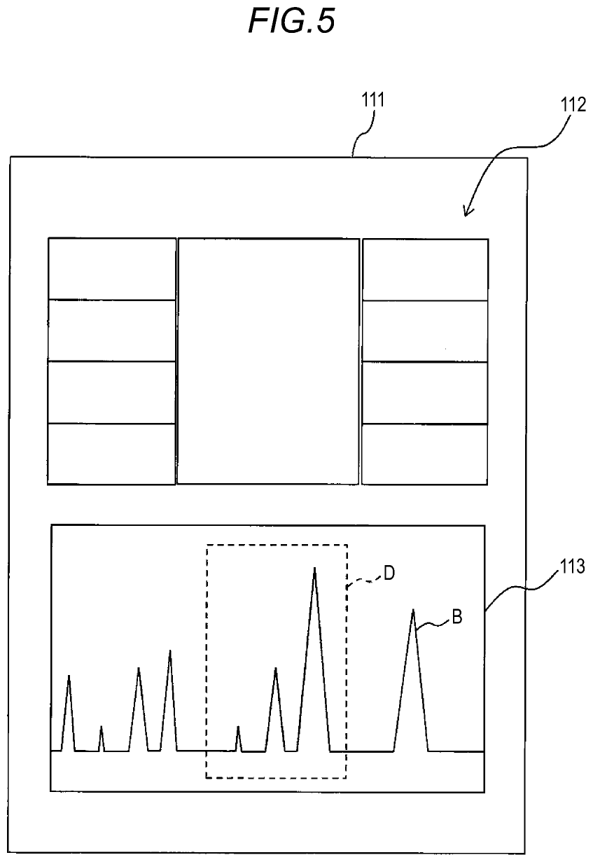

FIG. 4 is a flowchart illustrating a process in a state of a backflush setting mode as an example of a process by the controller 13. In addition, FIG. 5 is a schematic view illustrating an example in which the entire chromatogram is displayed as an example of a display mode of the display screen in the state of the backflush setting mode.

As described above, in this gas chromatograph, the backflush operation may be performed. In addition, the backflush operation is started according to a preset time (start timing). Further, as described below, the time is set based on a touch operation on the display screen 111 in the state of the backflush setting mode.

Specifically, when a predetermined touch operation for selecting the backflush setting mode on the display screen 111 is performed by the operator (YES in step S101) in a state in which the analysis operation in the gas chromatograph is finished, the display processing unit 132 reads detection data 121 corresponding to an analyzed chromatogram from the storage unit 12 and displays the entire chromatogram corresponding to the detection data 121 in the graph area 113 as a graph B (step S102). The graph B does not move in the graph area 113, and a shape thereof is fixed.

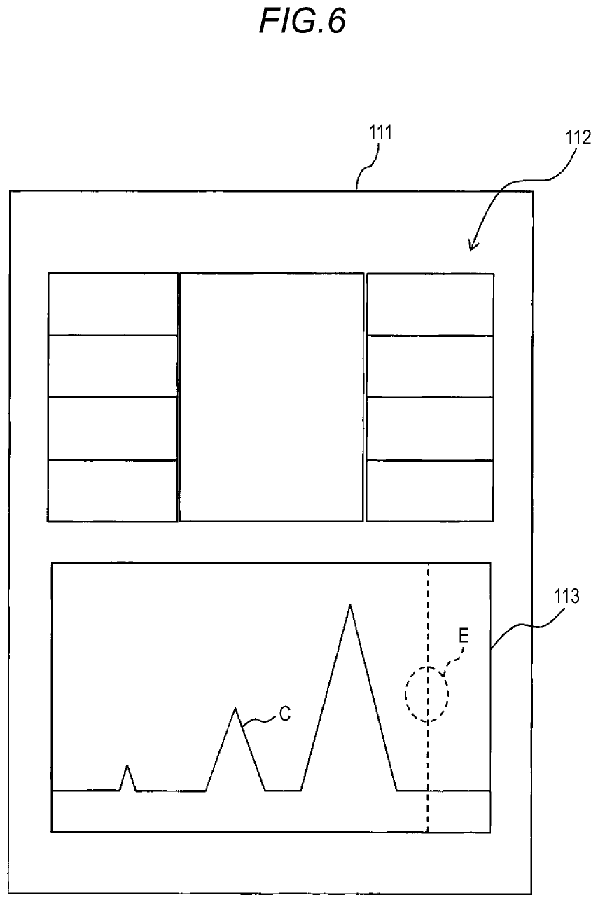

Then, when the operator touches two arbitrary portions in the graph area 113, and then performs a slide operation (pinch-out) by extending the touched portions from this state (YES in step S103), the display processing unit 132 enlarges and displays the chromatogram displayed in the graph area 113. Specifically, as illustrated in FIG. 6, the display processing unit 132 displays a graph C in which the chromatogram displayed in the graph area 113 is enlarged and displayed on the time axis (horizontal axis).

FIG. 6 is a schematic view illustrating an example in which the chromatogram is enlarged and displayed on the time axis as an example of a display mode of the display screen 111 in the state of the backflush setting mode.

That is, when the operator performs a pinch-out operation on the graph area 113 in the state of the backflush setting mode, the display processing unit 132 enlarges and displays the chromatogram displayed in the graph area 113 by largely changing a magnification of the time axis while fixing a magnification of the signal intensity axis. FIG. 6 illustrates a state of the display screen 111 when the pinch-out operation is performed on an area D illustrated in FIG. 5.

In addition, although not illustrated, from this state, when the operator touches two arbitrary portions in the graph area 113, and then performs a slide operation (pinch-in) by narrowing the touched portions from this state, the display processing unit 132 displays a graph obtained by reducing the graph C in the graph area 113. In addition, when the operator touches one arbitrary portion in the graph area 113, and then slides (swipes) the touched portion in a horizontal direction from this state, the graph C is moved in a slide direction.

In this way, a chromatogram having a shape suitable for setting the time is displayed in the graph area 113.

Then, when the operator shortly touches (taps) one arbitrary portion in the graph area 113 (YES in step S105), the setting processing unit 133 selects a time located at a center of the touched portion (tap portion), and sets the time as a time at which a backflush operation starts (step S106). FIG. 6 illustrates a state in which a time t located at a center of an area E is set as a time at which a backflush operation starts as a result of the area E being tapped by the operator.

In addition, also in a case in which a tap operation is performed (in a case in which a tap operation is performed on the graph area 113 in the state illustrated in FIG. 5) without a pinch-out operation being performed on the graph area 113 (NO in step S103) in the state of the backflush setting mode, a time located at a center of a tap portion is selected, and the time is set as a time at which a backflush operation starts as in the above description.

In this way, when the analysis operation is started again in the gas chromatograph after a time is set by the setting processing unit 133, the determination processing unit 134 determines timing corresponding to a set time during analysis based on the set time and detection data 121 corresponding to a real-time chromatogram. Then, upon determining the timing corresponding to the set time, the determination processing unit 134 controls operations of various components in the gas chromatograph to start the backflush operation.

(2) Ignition Setting Mode

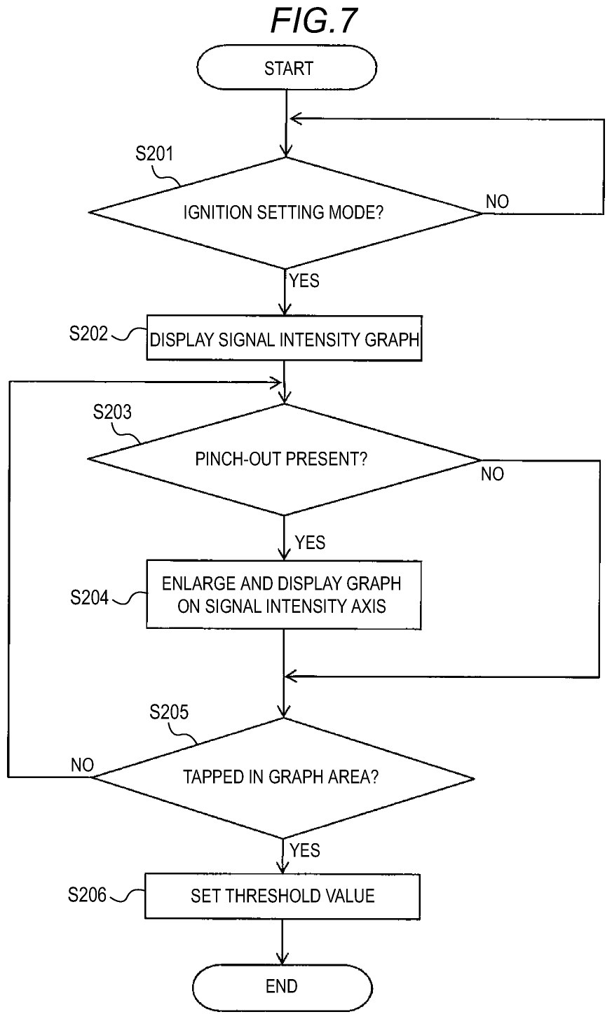

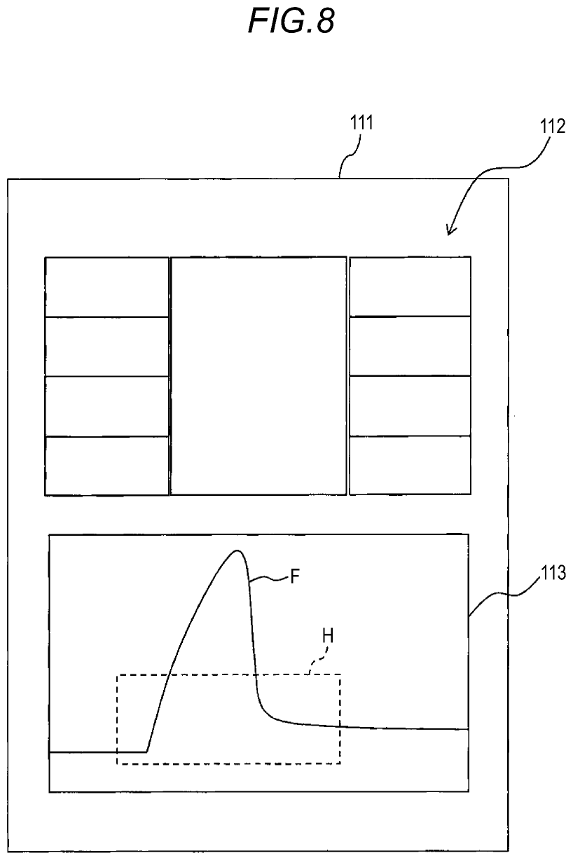

FIG. 7 is a flowchart illustrating a process in a state of an ignition setting mode as an example of a process by the controller 13. In addition, FIG. 8 is a schematic view illustrating an example in which an entire signal intensity graph is displayed as an example of a display mode of the display screen 111 in the state of the ignition setting mode.

In the gas chromatograph, in addition to the operation described above, an operation of verifying whether the detector 4 normally operates is performed.

Specifically, in the gas chromatograph, the data processing unit 131 creates signal intensity data based on a detection signal when the detector 4 is activated. The data is stored in the storage unit 12 as the detection data 121.

The determination processing unit 134 reads the detection data 121 from the storage unit 12, and determines that the detector 4 normally operates when signal intensity is larger than a preset threshold value. Then, the analysis operation in the gas chromatograph is started.

Here, depending on the usage condition of the gas chromatograph, the preset threshold value may not be an appropriate value in some cases. To cope with such a case, the setting processing unit 133 sets the threshold value again based on a touch operation on the display screen 111 as described below.

Specifically, when a predetermined touch operation for selecting the ignition setting mode is performed on the display screen 111 by the operator (YES in step S201), the display processing unit 132 reads the detection data 121 from the storage unit 12, and displays an entire signal intensity graph (graph of signal intensity data) corresponding to the detection data 121 as a graph F in the graph area 113 (step S202). The graph F does not move in the graph area 113, and a shape thereof is fixed.

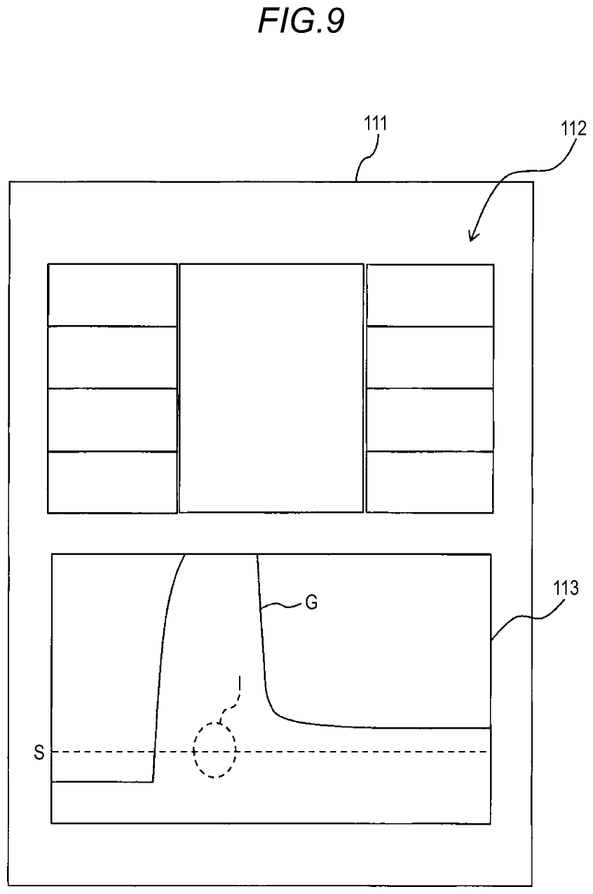

Then, when the operator touches two arbitrary portions in the graph area 113, and then performs a slide operation (pinch-out) by extending the touched portions from this state (YES in step S203), the display processing unit 132 enlarges and displays the signal intensity graph displayed in the graph area 113. Specifically, as illustrated in FIG. 9, the display processing unit 132 displays a graph G in which the signal intensity graph displayed in the graph area 113 is enlarged and displayed on the signal intensity axis (vertical axis).

FIG. 9 is a schematic view illustrating an example in which the signal intensity graph is enlarged and displayed on the signal intensity axis as an example of a display mode of the display screen 111 in the state of the ignition setting mode.

That is, when the operator performs a pinch-out operation on the graph area 113 in the state of the ignition setting mode, the display processing unit 132 enlarges and displays the signal intensity graph displayed in the graph area 113 by largely changing a magnification of the signal intensity axis while fixing a magnification of the time axis. FIG. 9 illustrates a state of the display screen 111 when the pinch-out operation is performed on an area H illustrated in FIG. 8.

In addition, although not illustrated, from this state, when the operator touches two arbitrary portions in the graph area 113, and then performs a slide operation (pinch-in) by narrowing the touched portions from this state, the display processing unit 132 displays a graph obtained by reducing the graph G in the graph area 113. In addition, when the operator touches one arbitrary portion in the graph area 113, and then slides (swipes) the touched portion in the vertical direction from this state, the graph G is moved in a slide direction.

In this way, a signal intensity graph having a shape suitable for setting the threshold value is displayed in the graph area 113.

Then, when the operator shortly touches (taps) one arbitrary portion in the graph area 113 (YES in step S205), the setting processing unit 133 selects signal intensity located at a center of the touched portion (tap portion), and sets the signal intensity as the threshold value (step S206). FIG. 9 illustrates a state in which signal intensity S located at a center of an area I is set as the threshold value used when an operation situation of the detector 4 is checked as a result of the area I being tapped by the operator.

In addition, also in a case in which a tap operation is performed (in a case in which a tap operation is performed on the graph area 113 in the state illustrated in FIG. 8) without a pinch-out operation being performed on the graph area 113 (NO in step S203) in the state of the ignition setting mode, signal intensity located at a center of a tap portion is selected, and the signal intensity is set as the threshold value as in the above description.

In this way, after the threshold value is set by the setting processing unit 133, the determination processing unit 134 determines whether the detector 4 normally operates based on the set threshold value and the detection data 121. For example, it is determined that an ignition state is obtained when the signal intensity exceeds the threshold value after ignition of the detector 4, and it is determined that a flame-out state is obtained when the signal intensity is below the threshold value after it is determined that the ignition state is obtained. Then, in the gas chromatograph, an analysis operation is performed in a state in which it is determined that the detector 4 normally operates (in a state in which it is determined that the ignition state is obtained).

### 5. Effects

(1) In the present embodiment, in the gas chromatograph, the display unit 11 is provided in the main body 10. In addition, the touch panel-type display screen 111 is included in the display unit 11. Further, as illustrated in FIG. 6 and FIG. 9, the setting processing unit 133 performs setting related to the graph displayed in the graph area 113 based on the touch operation on the graph area 113 of the display screen 111.

For this reason, the operator may perform setting related to the graph displayed in the graph area 113 of the display screen 111 only by performing the touch operation on the touch panel-type display screen 111 provided in the main body 10.

That is, the setting related to the graph displayed in the graph area 113 can be easily performed only by the touch operation on the main body 10.

(2) In addition, in the present embodiment, as illustrated in FIG. 6 and FIG. 9, the display processing unit 132 enlarges and displays the graph displayed in the graph area 113 based on the touch operation on the graph area 113 on the display screen 111. In addition, the setting processing unit 133 performs setting related to the graph based on the touch operation on the graph area 113 in a state in which the graph is enlarged and displayed.

For this reason, the operator may perform setting related to the graph by enlarging and displaying a part to be noticed in the graph displayed in the graph area 113 and performing the touch operation on the graph area 113 subjected to enlarging and displaying.

As a result, it is possible to perform detailed setting related to the graph only by performing the touch operation on the graph area 113.

(3) In addition, in the present embodiment, as illustrated in FIG. 6 and FIG. 9, the display processing unit 132 displays the graph in the graph area 113 by biaxial display of the vertical axis and the horizontal axis, and changes only a magnification of one of the vertical axis or the horizontal axis in the graph displayed in the graph area 113 based on the touch operation on the graph area 113 on the display screen 111, thereby enlarging and displaying the graph.

For this reason, it is possible to enlarge and display the graph in a mode in which setting is easily performed in the graph area 113 corresponding to a limited area by changing only a magnification of one axis to be set rather than changing magnifications of both the vertical axis and the horizontal axis.

As a result, it is possible to perform detailed setting related to the vertical axis of the graph or detailed setting related to the horizontal axis of the graph.

(4) In addition, in the present embodiment, as illustrated in FIG. 6, the display processing unit 132 displays the chromatogram when the sample is detected by the detector 4 in the graph area 113 by biaxial display in which the vertical axis represents the signal intensity of the detector 4 and the horizontal axis represents time. In addition, the display processing unit 132 enlarges and displays the chromatogram by changing only the magnification of the horizontal axis (time axis) in the chromatogram displayed in the graph area 113 based on the touch operation on the graph area 113 on the display screen 111. Then, the setting processing unit 133 sets time in the backflush operation based on the touch operation on the graph area 113 in which the chromatogram is enlarged and displayed.

For this reason, it is possible to enlarge and display the chromatogram in a mode in which setting related to time is easy to perform, and then perform the setting in detail.

(5) In addition, in the present embodiment, as illustrated in FIG. 9, the display processing unit 132 displays a graph representing a change in signal intensity when the detector 4 is activated in the graph area 113 by biaxial display in which the vertical axis represents the signal intensity of the detector 4 and the horizontal axis represents time. In addition, the display processing unit 132 enlarges and displays the graph by changing only the magnification of the vertical axis (signal intensity axis) in the graph displayed in the graph area 113 based on the touch operation on the graph area 113 on the display screen 111. Then, the setting processing unit 133 sets the threshold value of the signal intensity of the detector 4 based on the touch operation on the graph area 113 in which the graph is enlarged and displayed.

For this reason, it is possible to enlarge and display the graph in a mode in which setting related to the threshold value of the signal intensity of the detector 4 is easy to perform, and then perform the setting in detail.

### 6. Modification

A description has been given above on the assumption that the analysis apparatus of the invention corresponds to the gas chromatograph. However, the analysis apparatus of the invention is applicable to an analysis apparatus other than the gas chromatograph.

In addition, a description has been given above on the assumption that a point in time or a threshold value at one arbitrary portion displayed in the graph area 113 is set based on the touch operation on the graph area 113. However, the number of set points in time or threshold values is not limited to one, and a plurality of points in time or threshold values may be set. For example, in the case of performing heart cut or fractionation in the analysis apparatus, a plurality of points in time at which a flow path is switched may be set based on a touch operation on a plurality of arbitrary portions with respect to the graph area 113.

In addition, a description has been given above on the assumption that the detector 4 corresponds to the flame ionization detector (FID). However, the detector 4 may correspond to another detector which is ignited and used. For example, the detector 4 may correspond to a flame photometric detector (FPD).

### REFERENCE SIGNS LIST

4 detector

10 main body

11 display unit

13 controller

111 display screen

113 graph area

132 display processing unit

133 setting processing unit

1. An analysis apparatus comprising:
a main body;
a detector provided in the main body, the detector detecting a sample and outputting a detection signal;
a display unit provided in the main body, the display unit having a touch panel-type display screen;
a display processing unit that displays a graph in a graph area on the display screen based on the detection signal from the detector; and
a setting processing unit that, in a case where a mode in which setting related to time is performed is selected, performs the setting related to time in a state where a chromatogram is enlarged and displayed by changing only a magnification of a horizontal axis which is a time axis in the chromatogram displayed in the graph area, based on a pinch-out operation on the graph area on the display screen, and that, in a case where a mode in which setting related to a threshold value of a signal intensity of the detector is performed is selected, performs the setting related to a threshold value of a signal intensity in a state where a graph is enlarged and displayed by changing only a magnification of a vertical axis, which is a signal intensity axis in the graph displayed in the graph area, based on the pinch-out operation on the graph area on the display screen,
wherein the setting processing unit sets a time or a threshold value so that the analysis apparatus proceeds a predetermined operation after triggering at least one of the time or the threshold value.

2. The analysis apparatus according to claim 1,
wherein the display processing unit enlarges and displays the graph displayed in the graph area based on a touch operation on the graph area on the display screen, and
the setting processing unit performs setting related to the graph based on a touch operation on the graph area in which the graph is enlarged and displayed.

3. The analysis apparatus according to claim 2, wherein the display processing unit displays a graph in the graph area by biaxial display of a vertical axis and a horizontal axis, and changes a magnification of one of the vertical axis or the horizontal axis in the graph displayed in the graph area based on a touch operation on the graph area on the display screen, thereby enlarging and displaying the graph.

4. The analysis apparatus according to claim 3,
wherein the display processing unit displays a chromatogram when a sample is detected by the detector in the graph area by biaxial display in which a vertical axis represents signal intensity of the detector and a horizontal axis represents time, and changes only a magnification of the horizontal axis in the chromatogram displayed in the graph area based on a touch operation on the graph area on the display screen, thereby enlarging and displaying the chromatogram, and
the setting processing unit sets the time based on a touch operation on the graph area in which the chromatogram is enlarged and displayed.

5. The analysis apparatus according to claim 3,
wherein the display processing unit displays a graph representing a change in signal intensity when the detector is activated in the graph area by biaxial display in which a vertical axis represents signal intensity of the detector and a horizontal axis represents time, and changes only a magnification of the vertical axis in the graph displayed in the graph area based on a touch operation on the graph area on the display screen, thereby enlarging and displaying the graph, and
the setting processing unit sets the threshold value of the signal intensity of the detector based on a touch operation on the graph area in which the graph is enlarged and displayed.
